(19) United States
(12) Patent Application Publication
(10) Pub. No.: US 2025/0260331 A1
(43) Pub. Date: Aug. 14, 2025

(54) SUBMARINE DCDC CONVERTER, METHOD FOR CONTROLLING SUBMARINE DCDC CONVERTER, AND SUBMARINE CABLE SYSTEM

(71) Applicant: NEC Corporation, Tokyo (JP)

(72) Inventor: Yoshinari TAKIGAWA, Tokyo (JP)

(73) Assignee: NEC Corporation, Tokyo (JP)

(21) Appl. No.: 19/043,569

(22) Filed: Feb. 3, 2025

(30) Foreign Application Priority Data
Feb. 13, 2024 (JP) 2024-019563

(51) Int. Cl. H02M 3/38; H01B 7/14; H02M 1/00

(52) U.S. Cl. CPC H02M 3/38; H01B 7/14; H02M 1/0087; H02M 1/009

(57) ABSTRACT

To share, i.e., to use, a common submarine DCDC converter for both a submarine DCDC converter for positive outputting and one for negative outputting. A submarine DCDC converter according to the present disclosure includes: a DCDC conversion circuit configured to supply a first constant current input to an input terminal from a land feeding apparatus through a first submarine cable to a first output terminal, generate a second constant current using the first constant current, and supply the generated second constant current to a second output terminal; a control circuit configured to switch a polarity of the second constant current output from the second output terminal; a first switch; and a second switch.

### INCORPORATION BY REFERENCE

This application is based upon and claims the benefit of priority from Japanese patent application No. 2024-019563, filed on Feb. 13, 2024, the disclosure of which is incorporated herein in its entirety by reference.

### TECHNICAL FIELD

The present disclosure relates to a submarine DCDC converter, a method for controlling a submarine DCDC converter, and a submarine cable system.

### BACKGROUND ART

In general, a submarine cable system has a configuration in which a plurality of submarine apparatuses such as repeaters and branching units are connected one after another in a chain-like manner by submarine cables. Such submarine cables are equipped with respective feeder lines. A power supply circuit of each submarine apparatus is connected to the respective feeder line so as to form a series circuit. A constant feeding current is supplied to this feeder line from feeding apparatuses provided at land stations located at both ends of the feeder line. Each submarine apparatus uses electric power corresponding to the voltage drop of the feeding current (which is disclosed, for example, in Japanese Unexamined Patent Publication No. 2017-184473 (Patent Literature 1)).

According to Patent Literature 1, each submarine apparatus includes a plurality of main DC/DC converters each of which converts first DC power supplied from the land feeding apparatus through the submarine cable into second DC power. The second DC power supplied from each main DC/DC converter is converted into third DC power by an output DC/DC converter and is then output to a respective one of a plurality of observation apparatuses. Further, on the primary side of each main DC/DC converter, a switch for switching the state on the primary side between an open state and a closed state is connected in parallel therewith. The land control apparatus switches each switch between the open state and the closed state, and by doing so, prevents electric power from being wastefully consumed.

Regarding submarine cable systems, there are cases where if a submarine cable is branched by using a submarine branching unit (BU: Branching Unit) to supply electric power to a node or the like disposed on the seabed, or if a feeding apparatus cannot be installed at the end of a branched cable, a submarine DCDC converter is provided on the branched side. The submarine DCDC converter supplies electric power to a submarine cable or a submarine apparatus disposed on the branched side.

Further, there are cases where if two submarine cable systems are connected to each other (hereinafter also expressed as “being interconnected”), a DCDC converter is provided under the sea in order to supply electric power to the interconnected section of the two submarine cables. In recent years, there has been a demand for adopting a configuration in which electric power is supplied from both ends of a feeder line (hereinafter also referred to as “both-end power supply configuration”) to such an interconnected section of two submarine cable systems as in the case of the configuration in which electric power is supplied from feeding apparatuses provided in land stations. To adopt such a both-end power supply configuration, it is necessary to arrange two DCDC converters so as to face each other in the interconnected section, and perform constant-current control so that one of the DC converters performs positive (+) outputting and the other of the DC converters performs negative (−) outputting.

As a result, there is a problem that it is necessary to prepare each of a DCDC converter for positive outputting and a DCDC converter for negative outputting. Further, it is necessary to prepare a spare apparatus for each submarine apparatus so that the submarine apparatus is replaced with the spare apparatus in case where the submarine apparatus is broken and repaired. Therefore, it is necessary to prepare a spare apparatus for each of the DCDC converter for positive outputting and the one for negative outputting.

### SUMMARY

In view of the problems described above, an object of the present disclosure is to provide a submarine DCDC converter, a method for controlling a submarine DCDC converter, and a submarine cable system using them, capable of making it possible to share, i.e., to use, a common DCDC converter for both a DCDC converter for positive outputting and one for negative outputting.

A submarine DCDC converter according to the present disclosure includes a DCDC conversion circuit and a polarity switching unit. The DCDC conversion circuit supplies a first constant current input to an input terminal from a land feeding apparatus through a first submarine cable to a first output terminal, generates a second constant current using the first constant current, and supplies the generated second constant current to a second output terminal. The polarity switching unit switches a polarity of the second constant current output from the second output terminal.

A method for controlling a submarine DCDC converter according to the present disclosure includes: supplying a first constant current input to an input terminal from a land feeding apparatus through a first submarine cable to a first output terminal, generating a second constant current using the first constant current, and supplying the generated second constant current to a second output terminal; and switching a polarity of the second constant current output from the second output terminal.

A submarine cable system according to the present disclosure includes:
a first submarine cable sub-system including: two land feeding apparatuses each of which is configured to supply a first constant current to a submarine cable; a submarine branching unit configured to branch the submarine cable; and a DCDC converter to which the first constant current is supplied from the branched submarine cable. The DCDC converter includes a DCDC conversion circuit and a polarity switching unit. The DCDC conversion circuit supplies the first constant current input to an input terminal to a first output terminal, generates a second constant current using the first constant current, and supplies the generated second constant current to a second output terminal. The polarity switching unit switches a polarity of the second constant current output from the second output terminal.

### BRIEF DESCRIPTION OF DRAWINGS

The above and other aspects, features and advantages of the present disclosure will become more apparent from the following description of certain exemplary example embodiments when taken in conjunction with the accompanying drawings, in which:

FIG. 1 shows an example of a configuration of a submarine cable system according to the present disclosure;

FIG. 2 shows an example of a configuration of a submarine DCDC converter shown in FIG. 1;

FIG. 3 shows another example of a configuration of the submarine DCDC converter shown in FIG. 1;

FIG. 4 is a diagram for explaining features of the submarine cable system shown in FIG. 1;

FIG. 5 shows another example of a configuration of a submarine cable system according to the present disclosure;

FIG. 6 shows a configuration of a comparative submarine cable system;

FIG. 7 shows a configuration of a submarine cable system according to a comparative example; and

FIG. 8 shows the configuration of the submarine cable system according to the comparative example.

### EXAMPLE EMBODIMENT

An example embodiment will be described hereinafter with reference to the drawings. Note that in the example embodiment, the same or equivalent elements are assigned the same reference numerals (or symbols), and redundant descriptions thereof will be omitted. The example embodiment relates to a submarine cable system that is laid on the seabed and supplies electric power from a feeding apparatus provided in a land station to a submarine apparatus through a submarine cable.

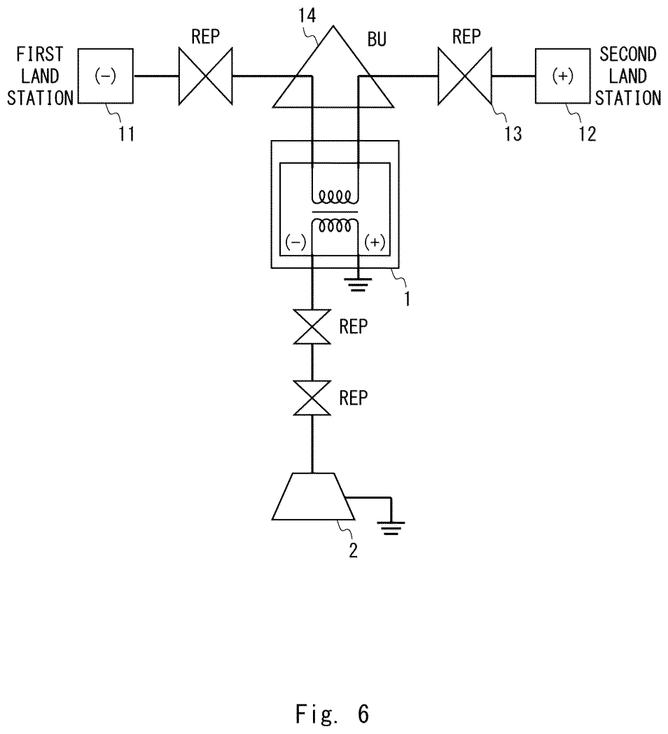

Firstly, a submarine cable system according to a comparative example will be described with reference to FIGS. 6 to 8. FIGS. 6 to 8 shows the configuration of the submarine cable system according to the comparative example. As shown in FIG. 6, in the submarine cable system according to the comparative example, a first land station and a second land station disposed on land are connected to each other by submarine cables. The submarine cable contains an optical fiber and a feeder line. The optical fiber includes a plurality of cores and transmits optical signals in both directions. Through the submarine cables, optical communication data and electric power are transmitted from the first land station located at one end of the submarine cables to the second land station located at the other end thereof. Submarine repeaters (REPs) 13 and a submarine branching unit (BU) 14 connected one after another in a chain-like manner by submarine cables are provided in a transmission path section between a first land feeding apparatus 11 and a second land feeding apparatus 12.

The first land feeding apparatus 11 is provided in the first land station, and the second land feeding apparatus 12 is provided in the second land station. The first and second land feeding apparatuses 11 and 12 perform both-end power supply using polarities different from each other. In the example shown in FIG. 6, the polarity of the first land feeding apparatus 11 is negative (−), and the polarity of the second land feeding apparatus 12 is positive (+). For a submarine apparatus such as the submarine repeater 13, electric power necessary for its operation is supplied through a feeder contained in the submarine cable. A constant current supplied between the first and second land stations is called a feeding current.

The submarine branching unit 14 branches the submarine cable and supplies electric power to a submarine node 2 disposed located on the seabed. As described above, if the submarine cable is branched in order to supply electric power to the submarine node 2 by using the submarine branching unit 14, a submarine DCDC converter 1 is provided between the submarine branching unit 14 and the submarine node 2. The submarine DCDC converter 1 includes a transformer for converting a first constant current supplied through the submarine cable on the branched side into a second constant current. The output electric power output from the submarine DCDC converter 1 is supplied to the submarine node 2 through the submarine repeater 13. Such a submarine DCDC converter 1 may also be provided even in a case where the end, i.e., the destination, of the branched cable is in an isolated island or the like and hence the construction work thereof is restricted, so that a feeding apparatus cannot be provided there.

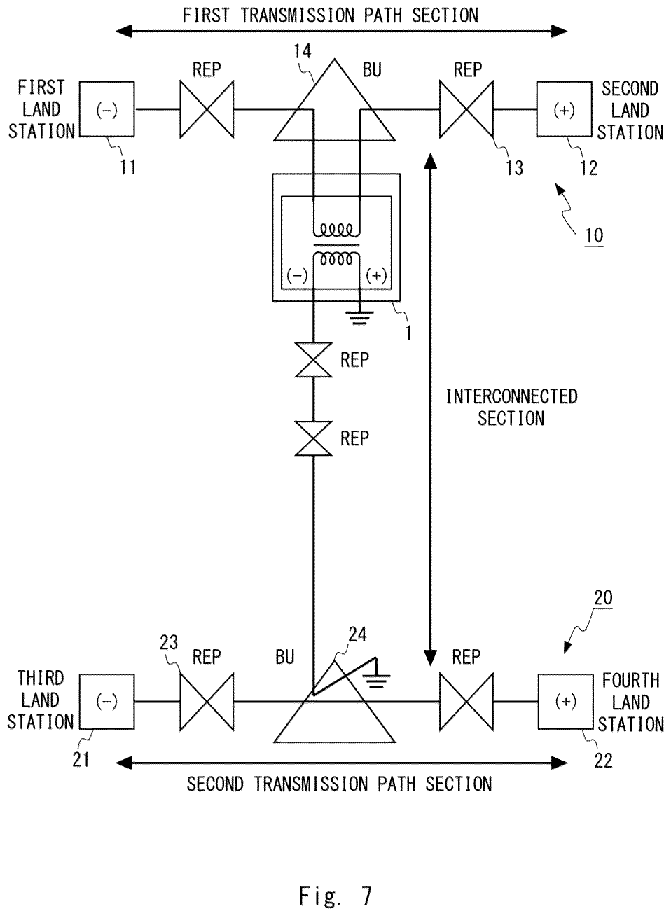

Further, as shown in FIG. 7, there is a case where a first submarine cable sub-system 10 and a second submarine cable sub-system 20 are interconnected, i.e., connected to each other. Note that the configurations of a first land feeding apparatus 11, a second land feeding apparatus 12, a submarine repeater 13, and a submarine branching unit 14 of the first submarine cable sub-system 10 and the configurations of a third land feeding apparatus 21, a fourth land feeding apparatus 22, a submarine repeater 23, and a submarine branching unit 24 of the second submarine cable sub-system 20 may be identical to each other. As described above, the submarine DCDC converter 1 may be used in order to supply electric power to the interconnected section of two submarine cables.

There is a demand for adopting a both-end power supply configuration even to such an interconnected section of two submarine cable systems as in the case of the configuration in which electric power is supplied from the first and second land feeding apparatuses 11 and 12 provided in the land stations. To adopt such a both-end power supply configuration, it is necessary to arrange two submarine DCDC converters 1 so as to face each other in the interconnected section, and perform constant-current control so that one of the DC converters 1 performs positive (+) outputting and the other of the DC converters 1 performs negative (−) outputting.

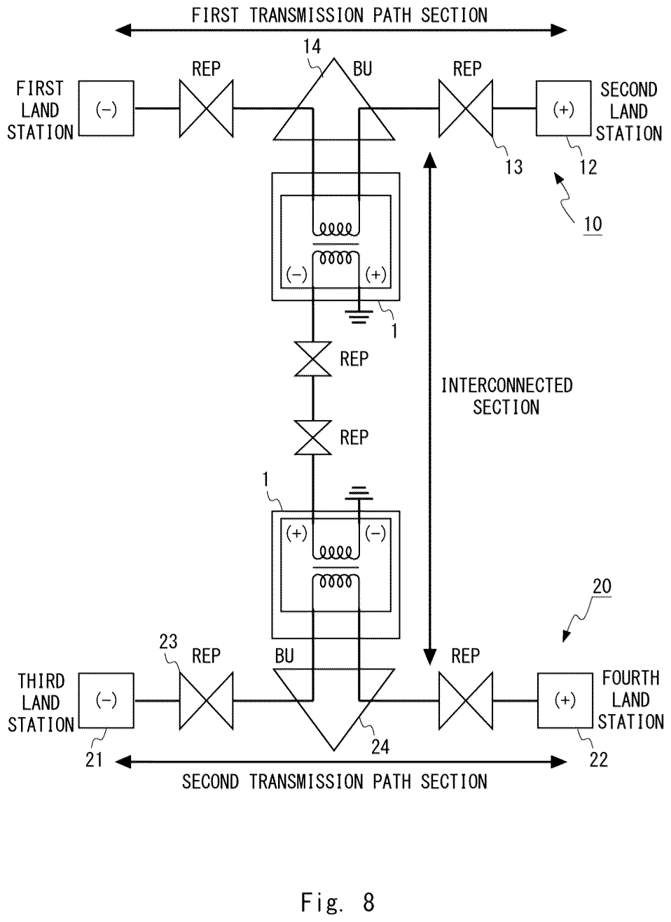

By adopting the both-end power supply configuration as described above, even if a ground fault failure occurs in the interconnected section of submarine cables, electric power is supplied from each of the two submarine DCDC converters 1 to the failed part, thus making it possible to maintain the supply of electric power in the interconnected section. However, as shown in FIG. 8, there is a problem that it is necessary to prepare each of a submarine DCDC converter for positive outputting and one for negative outputting. Further, it is necessary to prepare a spare apparatus for each submarine apparatus so that the submarine apparatus is replaced with the spare apparatus if the submarine apparatus is broken and repaired. Therefore, it is necessary to prepare a spare apparatus for each of the marine DCDC converter for positive outputting and the one for negative outputting. Therefore, the inventors of the present disclosure have conceived a configuration described below in order to share, i.e., to use, a common submarine DCDC converter for both a DCDC converter for positive outputting and one for negative outputting.

A submarine cable system 100 according to the present disclosure will be described hereinafter with reference to the drawings. Note that in the example of the submarine cable system 100 shown below, it is assumed that a first land station and a second land station both of which are located on land are connected to each other by submarine cables, and thereby forming a first transmission path section of a first submarine cable sub-system 10, and a third land station and a fourth land station are connected to each other by submarine cables, and thereby forming a second transmission path section of a second submarine cable sub-system 20.

The first land station includes the first land feeding apparatus 11; the second land station includes the second land feeding apparatus 12; the third land station includes the submarine repeater 13; and the fourth land station includes the submarine branching unit 14. In the first transmission path section, optical communication data and electric power are transmitted between the first land station located at one end and the second land station located at the other end. Further, in the second transmission path section, optical communication data and electric power are transmitted from the third land station located at one end to the fourth land station located at the other end.

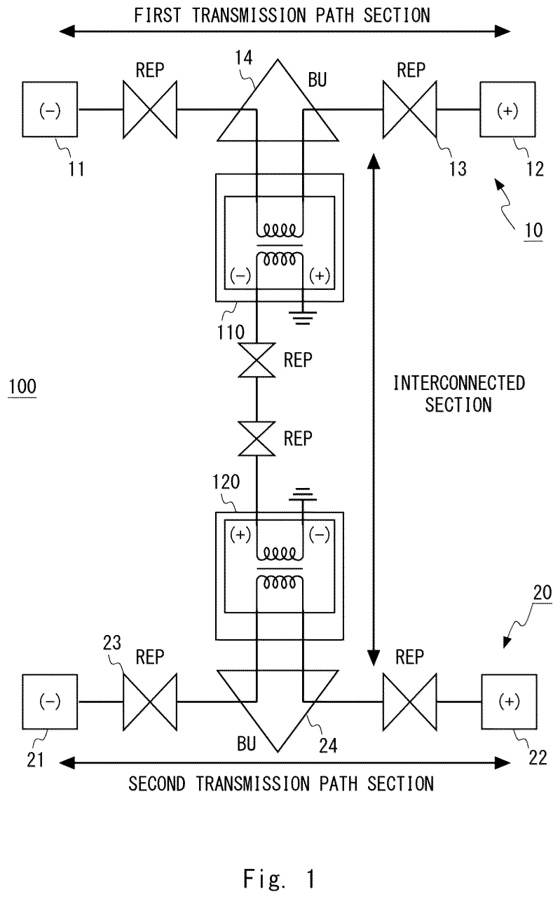

FIG. 1 shows an example of a configuration of the submarine cable system 100 according to the present disclosure. As shown in FIG. 1, the submarine cable system 100 includes a first submarine cable sub-system 10 and a second submarine cable sub-system 20. Similarly to the configuration described above, each of the first and second submarine cable sub-systems 10 and 20 performs both-end power supply. The first submarine cable sub-system 10 includes the first land feeding apparatus 11, the second land feeding apparatus 12, the submarine repeater 13, the submarine branching unit 14, and a first submarine DCDC converter 110. The first and second land feeding apparatuses 11 and 12 are connected to each other by submarine cables. The submarine repeater 13 and the submarine branching unit 14 connected one after another in a chain-like manner by a submarine cable are provided in a transmission path section between the first and second land feeding apparatuses 11 and 12.

The second submarine cable sub-system 20 includes the third land feeding apparatus 21, the fourth land feeding apparatus 22, the submarine repeater 23, the submarine branching unit 24, and a second submarine DCDC converter 120. The submarine repeater 23 and the submarine branching unit 24 connected one after another in a chain-like manner by a submarine cable are provided in a transmission path section between the third and fourth land feeding apparatuses 21 and 22 connected to each other by submarine cables.

As described above, the first and second submarine cable sub-systems 10 and 20 may have configurations roughly identical to each other. The configuration of the first submarine cable sub-system 10 will be described hereinafter while omitting redundant descriptions for simplifying the explanation.

In a case where the submarine repeater 13 transmits an optical signal from one of the land stations to the other land station, it compensates for the attenuation or degradation of the optical signal that occurs during the propagation thereof by reamplifying, regenerating, and reshaping the optical signal. Note that the number of components such as the submarine repeater 13 in the first submarine cable sub-system 10 is not limited to the number in this example. Further, the submarine cable system 100 may include other components not shown in FIG. 1.

The first and second submarine cable sub-systems 10 and 20 are interconnected between the submarine branching unit 14 and the submarine branching unit 24. The transmission path section in which the first and second submarine cable sub-systems 10 and 20 are interconnected is referred to as an interconnected section. Electric power is supplied to the interconnected section by the submarine branching unit 14 and the submarine branching unit 24, and the first submarine DCDC converter 110 and the second submarine DCDC converter 120 provided between the submarine branching unit 14 and the submarine branching unit 24.

The first submarine DCDC converter 110 performs negative outputting under constant-current control, and the second submarine DCDC converter 120 performs positive outputting under constant-current control. The output terminals of the first and second submarine DCDC converters 110 and 120 are connected to each other with two submarine repeaters interposed therebetween. In this way, both-end power supply can be performed in the interconnected section.

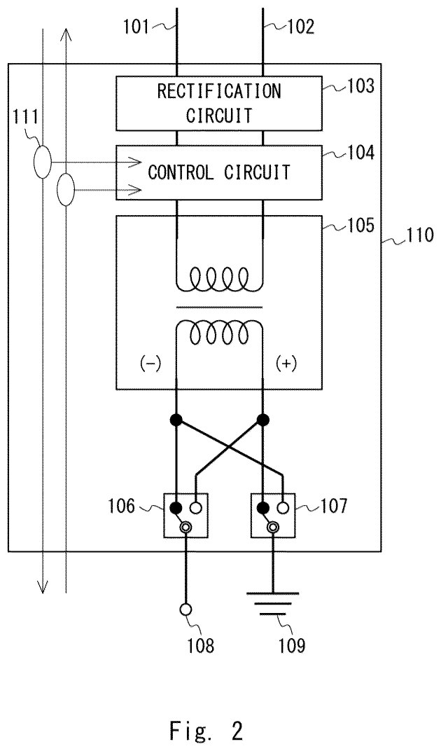

FIG. 2 shows a configuration of the first submarine DCDC converter 110. Note that the second submarine DCDC converter 120 may have a configuration similar to that shown in FIG. 2. The first submarine DCDC converter 110 includes an input terminal 101, a first output terminal 102, a rectification circuit 103, a control circuit 104, a DCDC conversion circuit 105, a first switch 106, a second switch 107, a second output terminal 108, a ground terminal 109, and an optical coupler 111. The feeding current supplied from the first submarine cable sub-system 10 is input to the input terminal 101 through the submarine branching unit 14.

The feeding current input to the input terminal 101 is rectified by the rectification circuit 103 irrespective of the direction of the feeding. The rectified current is input to the control circuit 104. The control circuit 104 controls the DCDC conversion circuit 105, the first switch 106, and the second switch 107. The DCDC conversion circuit 105 includes a transformer including a primary winding provided on the side on which the first output terminal 102 is located and a secondary winding provided on the side on which the second output terminal 108 is located. The DCDC conversion circuit 105 supplies a first constant current input to the primary winding side to the first output terminal 102, converts this first constant current into a second constant current, and outputs the second constant current to the secondary winding side. Electric power is supplied to the submarine cable under the constant-current control using a DC current, so that electric power equivalent to a value obtained by multiplying the electric power input to the primary winding of the DCDC conversion circuit 105 by the conversion efficiency thereof is obtained as the electric power on the secondary winding side.

One of the positive and negative outputs of the power supply on the secondary side is connected to the second output terminal 108 and the other is connected to the ground terminal 109. The second output terminal 108 is connected to the submarine cable in the interconnected section, and the ground terminal 109 is connected to the underwater ground electrode (sea earth). The first and second switches 106 and 107 are switches for switching the polarity of the output current output from the second output terminal 108 according to the control by the control circuit 104. That is, the first switch 106, the second switch 107, and the control circuit 104 constitute a polarity switching unit.

The first switch 106 is provided between the first terminal (negative (−) terminal in this example) on the secondary winding side of the DCDC conversion circuit 105 and the second output terminal 108. The second switch 107 is provided between the second terminal (positive (+) terminal in this example) on the secondary winding side of the DCDC conversion circuit 105 and the ground terminal 109. A high-voltage relay for switching a feeding path can be used as each of the first and second switches 106 and 107. Note that since the first and second switches 106 and 107 operate simultaneously with each other, a double-pole double-throw switch is preferably used for them.

The optical coupler 111 branches a remote-control signal transmitted from the land station through an optical fiber for communication contained in the submarine cable in the interconnected section, and outputs the branched remote-control signal to the control circuit 104. The control circuit 104 switches the connection state of the first and second switches 106 and 107 based on the remote-control signal. Specifically, the control circuit 104 switches the connection state between a first state in which the first switch 106 connects the negative terminal to the second output terminal 108 and the second switch 107 connects the positive terminal to the ground terminal 109, and a second state in which the first switch 106 connects the negative terminal to the ground terminal 109 and the second switch 107 connects the positive terminal to the second output terminal 108.

The first and second submarine DCDC converters 110 and 120 have configurations identical to each other. In the case of the first submarine DCDC converter 110 for negative outputting shown in FIG. 1, the control circuit 104 connects the negative terminal to the second output terminal 108 and connects the positive terminal to the ground terminal 109 (first state) by switching the first and second switches 106 and 107. Further, in the case of the second submarine DCDC converter 120 for positive outputting shown in FIG. 1, the control circuit 104 connects the positive terminal to the second output terminal 108 and connects the negative terminal to the ground terminal 109 (second state) by switching the first and second switches 106 and 107. Since the control circuit 104 switches the first and second switches 106 and 107 as described above, it becomes possible to share, i.e., to use, the configuration of a common submarine DCDC converter for both a DCDC converter for positive outputting and one for negative outputting.

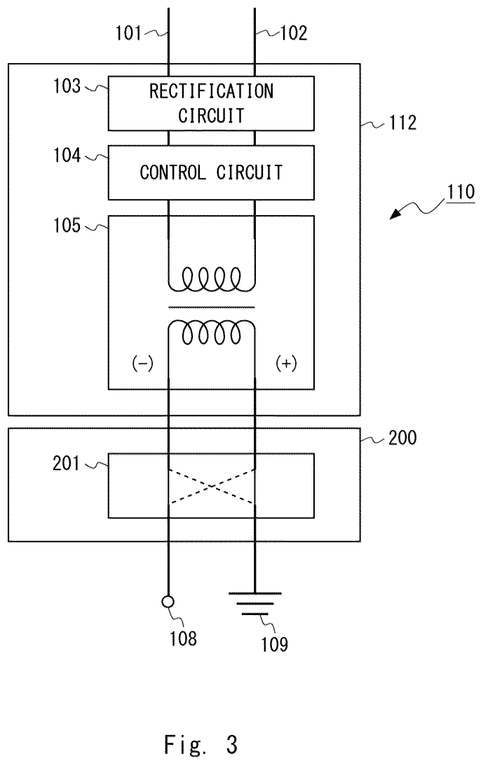

FIG. 3 shows another example of the configuration of the submarine DCDC converter shown in FIG. 1. In the example shown in FIG. 3, the first submarine DCDC converter 110 includes a conversion unit 112 including a rectification circuit 103, a control circuit 104, and a DCDC conversion circuit 105, and also includes a cable connection part 200. The cable connection part 200 is disposed outside the conversion unit 112.

A unit in which an electric circuit is provided, such as the conversion unit 112, is usually housed in a housing such as a metal pressure-resistant container capable of dissipating heat therethrough as in the case of the submarine repeater 13 or the like, covered with a pressure-resistant lid, sealed by welding, and then shipped from the factory. The cable connection part 200 serves as a connection part between such a conversion unit 112 and a submarine cable. The cable connection part 200 may be a cable coupling part or a cable joint part.

The cable coupling part is a connection part including a flexible wire called a tail cable, which is obtained by combining an optical fiber and a feeder line, and is made so as to withstand a high water pressure in the deep sea. Further, the cable joint part is a Universal Joint or the like specified and supplied by an industrial organization called Universal Jointing (UJ) Consortium. A cable coupling part used for the connection with a submarine cable may be connected to the conversion unit 112. Further, a cable joint part may be connected to the joint part of a connection between cables. A switching unit 201 for switching the polarity of a constant current output from the second output terminal is provided in the cable connection part 200.

In a case where a feeding current is input from a land feeding apparatus of the first submarine cable sub-system 10 or the second submarine cable sub-system 20 to the input terminal 101, the rectification circuit 103 rectifies the feeding current irrespective of the direction of the feeding. The rectified current is input to the control circuit 104. The control circuit 104 controls the DCDC conversion circuit 105.

The DCDC conversion circuit 105 includes a transformer including a primary winding provided on the side on which the first output terminal 102 is located and a secondary winding provided on the side on which the second output terminal 108 is located. The DCDC conversion circuit 105 supplies a first constant current input to the primary winding side to the first output terminal 102, converts this first constant current into a second constant current, and outputs the second constant current to the secondary winding side. Electric power is supplied to the submarine cable under the constant-current control using a DC current, so that electric power equivalent to a value obtained by multiplying the electric power input to the primary winding of the DCDC conversion circuit 105 by the conversion efficiency thereof is obtained as the electric power on the secondary winding side. One of the positive and negative outputs of the power supply on the secondary side is connected to the second output terminal 108 and the other is connected to the ground terminal 109.

In the example shown in FIG. 3, the switching unit 201 provided in the cable connection part 200 functions as a polarity switching unit. The switching unit 201 can switch the polarity of an output current output from the second output terminal 108. Specifically, the polarity of the output current output from the second output terminal 108 is switched by switching the connection of the feeder line provided in the above-described cable coupling part or the cable joint part. In the case of the first submarine DCDC converter 110 for negative outputting shown in FIG. 1, the switching unit 201 connects the negative terminal to the second output terminal 108 and connects the positive terminal to the ground terminal 109 (first state). Further, in the case of the second submarine DCDC converter 120 for positive outputting shown in FIG. 1, the switching unit 201 connects the positive terminal to the second output terminal 108 and connects the negative terminal to the ground terminal 109 (second state).

As described above, according to the configuration shown in FIG. 3, it is possible to switch the destination of the connection of the output on the secondary side of the DCDC conversion circuit 105 between the second output terminal 108 and the ground terminal 109 by switching the connection of the feeder line in the switching unit 201 provided in the cable connection part 200 disposed outside the housing without adding any other configuration in the first submarine DCDC converter 110 housed in the housing, and thereby to share, i.e., to use, the configuration of a common submarine DCDC converter for both a DCDC converter for positive outputting and one for negative outputting. In this case, the current apparatus, i.e., the existing apparatus, can also be used as the conversion unit 112. It is sufficient if the switching unit 201 is provided in the cable connection part 200 disposed outside the conversion unit 112 in a laying construction work which will be carried out later.

Note that the cable connection part 200 described above with reference to FIG. 3 is usually located several kilometers away from the first submarine DCDC converter 110. In a case where the polarity of the output current is to be changed, there is no need to pull up the first submarine DCDC converter 110 from the seabed. That is, only the cable connection part 200 is pulled up onto a ship and disassembled, and the connection of the feeder line of the switching unit 201 is switched. After the connection of the feeder line is switched, the switching unit 201 is sealed again in the cable connection part 200, and the cable connection part 200 is submerged to the seabed. In this way, it is possible to switch the polarity of the current output from the second output terminal 108 without pulling up the first submarine DCDC converter 110 itself.

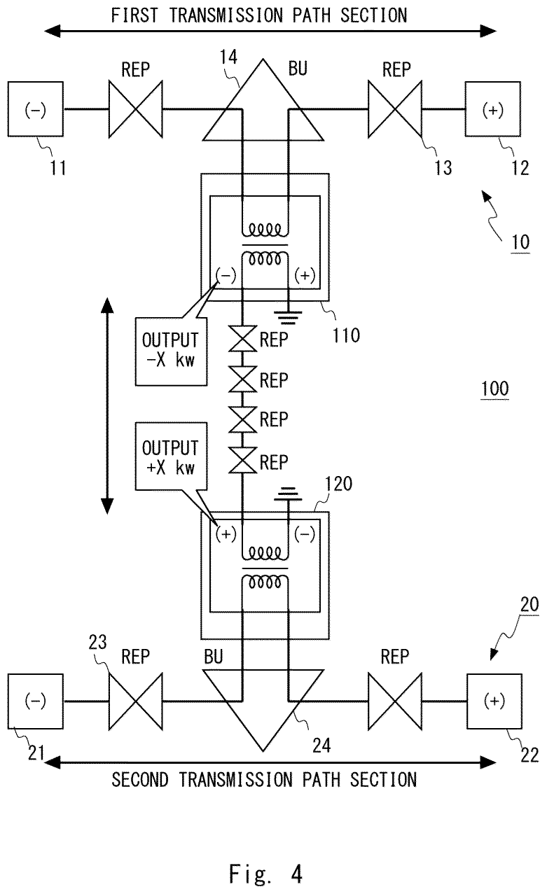

FIG. 4 is a diagram for explaining features of the submarine cable system shown in FIG. 1. Assuming that the limit of the output of one submarine DCDC converter 1 is X kW. Then, if one submarine DCDC converter 1 is provided in an interconnected section as shown in FIG. 7, the maximum electric power that can be supplied to the submarine cable and the repeater in the interconnected section is X kW. Note that it is conceivable that if the distance between the first and second submarine cable sub-systems 10 and 20 is large, the maximum power feeding capacity, which is X kW, is insufficient.

As shown in FIG. 4, if the submarine cable system 100 adopts a both-end power supply configuration using two submarine DCDC converters, i.e., first and second submarine DCDC converters 110 and 120, it is possible to supply electric power twice as much as that can be supplied by one submarine DCDC converter, i.e., to supply electric power that can be supplied by two submarine DCDC converters, even if the limit of the output of one first submarine DCDC converter 110 is X kW. In this way, it is possible to supply electric power to a submarine cable in a longer interconnected section. That is, in the case where the distance between the first and second submarine cable sub-systems 10 and 20 is large and the power feeding capacity of one submarine DCDC converter is not sufficient, it is possible to supply electric power to a longer interconnected section by adopting the configuration shown in FIG. 4.

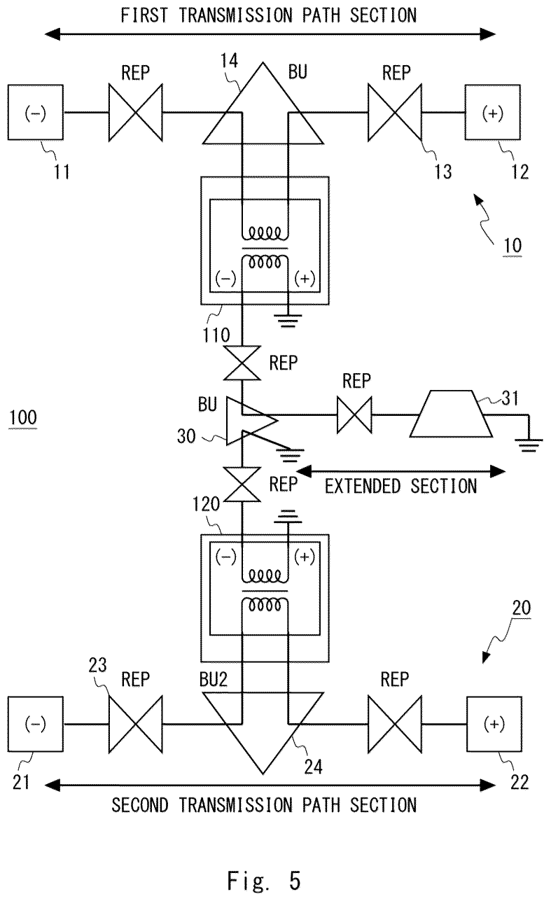

FIG. 5 shows another example of a configuration of a submarine cable system according to the present disclosure. In the example shown in FIG. 5, a submarine branching unit 30 is provided between first and second submarine DCDC converters 110 and 120 in an interconnected section. In an extended part branched from the submarine branching unit 30, a submarine node 31 is provided at the end of the submarine cable.

As shown in FIG. 5, the submarine branching unit 30 and the submarine node 31 are connected to an underwater ground electrode. Note that the underwater ground electrode must be fed with negative electric power. This is because if the underwater ground electrode is fed with positive electric power, the underwater ground electrode is gradually dissolved. As shown in FIG. 5, even if the configuration of the submarine cable system 100 is extended in the future, it is possible to continuously use the submarine cable system 100 as it is by changing the output polarities of the first and second submarine DCDC converters 110 and 120 without replacing the apparatus.

As described above, according to the present disclosure, it is possible to share, i.e., to use, the configuration of a common submarine DCDC converter as both of two submarine DCDC converters used for both-end power supply to an interconnected section between two submarine cable sub-systems. As a result, it is possible to reduce the cost for a spare apparatus for a submarine DCDC converter. Further, the spare apparatus can be used as either a submarine DCDC converter having a positive polarity or one having a negative polarity. Therefore, even in the case where a submarine DCDC converter is broken or damaged before being laid, it is possible to reduce the occurrence of a delay from the schedule related to the laying of the submarine cable system.

Further, in the case where the distance between two submarine cable sub-systems is large and the power feeding capacity of one submarine DCDC converter is insufficient, it is possible to increase the power feeding capacity by adding a submarine DCDC converter according to the present disclosure in an interconnected section, and thereby to supply electric power to a longer interconnected section. Further, even in the case where the submarine cable system is expanded in the future, it is possible to continuously use the apparatus already-laid on the seabed as it is without replacing the submarine DCDC converter.

Note that the present invention is not limited to the above-described example embodiment, and it can be modified as appropriate without departing from the scope and sprit of the invention.

According to the present disclosure, it is possible to share, i.e., to use, a common DCDC converter for both a DCDC converter for positive outputting and one for negative outputting.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims. The whole or part of the exemplary example embodiments disclosed above can be described as, but not limited to, the following supplementary notes.

### (Supplementary Note 1)

A submarine DCDC converter comprising:
a DCDC conversion circuit configured to supply a first constant current input to an input terminal from a land feeding apparatus through a first submarine cable to a first output terminal, generate a second constant current using the first constant current, and supply the generated second constant current to a second output terminal; and
a polarity switching unit configured to switch a polarity of the second constant current output from the second output terminal.

### (Supplementary Note 2)

The submarine DCDC converter described in Supplementary note 1, wherein
the DCDC conversion circuit comprises a transformer including a primary winding provided on a side on which the first output terminal is located and a secondary winding provided on a side on which the second output terminal is located, and
the polarity switching unit comprises:
a first switch disposed between a first terminal of the secondary winding and the second output terminal; and
a second switch disposed between a second terminal of the secondary winding and the second output terminal.

### (Supplementary Note 3)

The submarine DCDC converter described in Supplementary note 2, wherein the polarity switching unit switches a state of the submarine DCDC converter between
a first state in which the first switch connects the first terminal to the second output terminal, and the second switch connects the second terminal to an underwater ground electrode, and
a second state in which the first switch connects the first terminal to the underwater ground electrode, and the second switch connects the second terminal to the second output terminal.

### (Supplementary Note 4)

The submarine DCDC converter described in Supplementary note 1, wherein the polarity switching unit is disposed outside the DCDC conversion circuit and is disposed in a cable connection part configured to connect an output of the DCDC conversion circuit to the second output terminal.

### (Supplementary Note 5)

The submarine DCDC converter described in Supplementary note 2, further comprising a rectification circuit connected to both ends of the primary winding of the transformer and configured to rectify a current flowing through the primary winding.

### (Supplementary Note 6)

A method for controlling a submarine DCDC converter, comprising:
supplying a first constant current input to an input terminal from a land feeding apparatus through a first submarine cable to a first output terminal, generating a second constant current using the first constant current, and supplying the generated second constant current to a second output terminal; and
switching a polarity of the second constant current output from the second output terminal.

### (Supplementary Note 7)

A submarine cable system comprising:
a first submarine cable sub-system comprising:
two land feeding apparatuses each of which is configured to supply a first constant current to a submarine cable;
a submarine branching unit configured to branch the submarine cable; and
a DCDC converter to which the first constant current is supplied from the branched submarine cable, wherein
the DCDC converter comprising:
a DCDC conversion circuit configured to supply the first constant current input to an input terminal to a first output terminal, generate a second constant current using the first constant current, and supply the generated second constant current to a second output terminal; and
a polarity switching unit configured to switch a polarity of the second constant current output from the second output terminal.

### (Supplementary Note 8)

The submarine cable system described in Supplementary note 7, further comprising a second submarine cable sub-system having a configuration similar to that of the first submarine cable sub-system, wherein
DCDC converters are arranged so as to face each other in an interconnected section between the first and second submarine cable sub-systems, and
a polarity of a current output from one of the DCDC converters is different from that of a current output from the other DCDC converter.

### (Supplementary Note 9)

The submarine cable system described in Supplementary note 8, wherein
the DCDC conversion circuit comprises a transformer including a primary winding provided on a side on which the first output terminal is located and a secondary winding provided on a side on which the second output terminal is located,
the polarity switching unit comprises:
a first switch disposed between a first terminal of the secondary winding and the second output terminal; and
a second switch disposed between a second terminal of the secondary winding and the second output terminal,
the polarity switching unit switches a state of the submarine DCDC converter between
a first state in which the first switch connects the first terminal to the second output terminal, and the second switch connects the second terminal to an underwater ground electrode, and
a second state in which the first switch connects the first terminal to the underwater ground electrode, and the second switch connects the second terminal to the second output terminal, and
the first submarine cable sub-system is in one of the first and second states, and the second submarine cable sub-system is in the other of the first and second states.

### (Supplementary Note 10)

The submarine cable system described in Supplementary note 8, further comprising:
a branching unit configured to branch a connection cable connecting two DCDC converters to each other; and
a submarine apparatus to which electric power is supplied through the branching unit.

What is claimed is:

1. A submarine DCDC converter comprising:
a DCDC conversion circuit configured to supply a first constant current input to an input terminal from a land feeding apparatus through a first submarine cable to a first output terminal, generate a second constant current using the first constant current, and supply the generated second constant current to a second output terminal; and
a polarity switching unit configured to switch a polarity of the second constant current output from the second output terminal.

2. The submarine DCDC converter according to claim 1, wherein
the DCDC conversion circuit comprises a transformer including a primary winding provided on a side on which the first output terminal is located and a secondary winding provided on a side on which the second output terminal is located, and
the polarity switching unit comprises:
a first switch disposed between a first terminal of the secondary winding and the second output terminal; and
a second switch disposed between a second terminal of the secondary winding and the second output terminal.

3. The submarine DCDC converter according to claim 2, wherein the polarity switching unit switches a state of the submarine DCDC converter between
a first state in which the first switch connects the first terminal to the second output terminal, and the second switch connects the second terminal to an underwater ground electrode, and
a second state in which the first switch connects the first terminal to the underwater ground electrode, and the second switch connects the second terminal to the second output terminal.

4. The submarine DCDC converter according to claim 1, wherein the polarity switching unit is disposed outside the DCDC conversion circuit and is disposed in a cable connection part configured to connect an output of the DCDC conversion circuit to the second output terminal.

5. The submarine DCDC converter according to claim 2, further comprising a rectification circuit connected to both ends of the primary winding of the transformer and configured to rectify a current flowing through the primary winding.

6. A method for controlling a submarine DCDC converter, comprising:
supplying a first constant current input to an input terminal from a land feeding apparatus through a first submarine cable to a first output terminal, generating a second constant current using the first constant current, and supplying the generated second constant current to a second output terminal; and
switching a polarity of the second constant current output from the second output terminal.

7. A submarine cable system comprising:
a first submarine cable sub-system comprising:
two land feeding apparatuses each of which is configured to supply a first constant current to a submarine cable;
a submarine branching unit configured to branch the submarine cable; and
a DCDC converter to which the first constant current is supplied from the branched submarine cable, wherein
the DCDC converter comprising:
a DCDC conversion circuit configured to supply the first constant current input to an input terminal to a first output terminal, generate a second constant current using the first constant current, and supply the generated second constant current to a second output terminal; and
a polarity switching unit configured to switch a polarity of the second constant current output from the second output terminal.

8. The submarine cable system according to claim 7, further comprising a second submarine cable sub-system having a configuration similar to that of the first submarine cable sub-system, wherein
DCDC converters are arranged so as to face each other in an interconnected section between the first and second submarine cable sub-systems, and
a polarity of a current output from one of the DCDC converters is different from that of a current output from the other DCDC converter.

9. The submarine cable system according to claim 8, wherein
the DCDC conversion circuit comprises a transformer including a primary winding provided on a side on which the first output terminal is located and a secondary winding provided on a side on which the second output terminal is located,
the polarity switching unit comprises:
a first switch disposed between a first terminal of the secondary winding and the second output terminal; and
a second switch disposed between a second terminal of the secondary winding and the second output terminal,
the polarity switching unit switches a state of the submarine DCDC converter between
a first state in which the first switch connects the first terminal to the second output terminal, and the second switch connects the second terminal to an underwater ground electrode, and
a second state in which the first switch connects the first terminal to the underwater ground electrode, and the second switch connects the second terminal to the second output terminal, and
the first submarine cable sub-system is in one of the first and second states, and the second submarine cable sub-system is in the other of the first and second states.

10. The submarine cable system according to claim 8, further comprising:
a branching unit configured to branch a connection cable connecting two DCDC converters to each other; and
a submarine apparatus to which electric power is supplied through the branching unit.
